(19) United States
(12) Patent Application Publication
(10) Pub. No.: US 2024/0008078 A1
(43) Pub. Date: Jan. 4, 2024

(54) Methods For Signaling Of UE-Initiated COT In Mobile Communications

(71) Applicant: MediaTek Singapore Pte. Ltd., Singapore (SG)

(72) Inventors: Abdellatif Salah, Cambridge (GB); Mohammed S Aleabe Al-Imari, Cambridge (GB)

(21) Appl. No.: 18/035,043

(22) PCT Filed: Nov. 3, 2021
(86) PCT No.: PCT/CN2021/128357

§ 371 Date: May 2, 2023

Related U.S. Application Data
(60) Provisional application No. 63/108,906, filed on Nov. 3, 2020.

(51) Int. Cl. H04W 74/08; H04W 74/00; H04L 5/00

(52) U.S. Cl. CPC H04W 74/0816; H04W 74/006; H04L 5/0051

(57) ABSTRACT

Various solutions for signaling of user equipment (UE)-initiated channel occupancy time (COT) in mobile communications are described. An apparatus, implementable in or as a UE, receives an indication from a network node of a wireless network. The apparatus determines, based on the indication, whether the network node is using a network-initiated COT or sharing a UE-initiated COT.

### CROSS REFERENCE TO RELATED PATENT APPLICATION

The present disclosure is part of U.S. National Stage filing of International Patent Application No. PCT/CN2021/128357, filed on 3 Nov. 2021, which is part of a non-provisional application claiming the priority benefit of U.S. Patent Application No. 63/108,906, filed on 3 Nov. 2020, the content of which being incorporated by reference in its entirety.

### TECHNICAL FIELD

The present disclosure is generally related to mobile communications and, more particularly, to techniques for signaling of user equipment (UE)-initiated channel occupancy time (COT) in mobile communications.

### BACKGROUND

Unless otherwise indicated herein, approaches described in this section are not prior art to the claims listed below and are not admitted as prior art by inclusion in this section.

In wireless communications, such as mobile communications under the 3 rd Generation Partnership Project (3GPP) specification(s) for 5^{th} Generation (5G) New Radio (NR), UE-to-network (e.g., gNB) COT sharing is supported. During a base station-initiated COT, a UE may still have the possibility to initiate its own COT. For example, if the UE has much more data to transmit under a configured grant (CG) and the network-initiated COT (herein interchangeably referred to as “gNB-initiated COT”) is not long enough, then the UE may initiate its own COT. As another example, if the UE did not detect a downlink (DL) traffic at the beginning of the network-initiated COT, then the UE may initiate its own COT. As yet another example, if the UE decided not to detect DL traffic at the beginning of every network fixed frame period (FFP) to save power, then the UE may initiate its own COT. During a UE-initiated COT, the network may also have the possibility to initiate its own COT (e.g., to also schedule and/or serve other UEs). However, once the UE has received an uplink (UL) grant, there is still ambiguity as to whether the UE is to use a network-initiated COT or whether the UE is to initiate its own COT. Therefore, there is a need for a solution of signaling of UE-initiated COT in mobile communications.

### SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions for signaling of UE-initiated COT in mobile communications.

In one aspect, a method may involve a UE receiving an indication from a network node of a wireless network. The method may also involve the UE determining, based on the indication, whether the network node is using a network-initiated COT or sharing a UE-initiated COT.

In another aspect, a method may involve a UE receiving downlink control information (DCI) from a network node of a wireless network scheduling an UL transmission in a future network FFP. The method may also involve the UE performing the UL transmission in the future network FFP.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a block diagram of an example communication apparatus and an example network apparatus in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to signaling of UE-initiated COT in mobile communications. According to the present disclosure, a number of possible solutions may be implemented separately or jointly. That is, although these possible solutions may be described below separately, two or more of these possible solutions may be implemented in one combination or another.

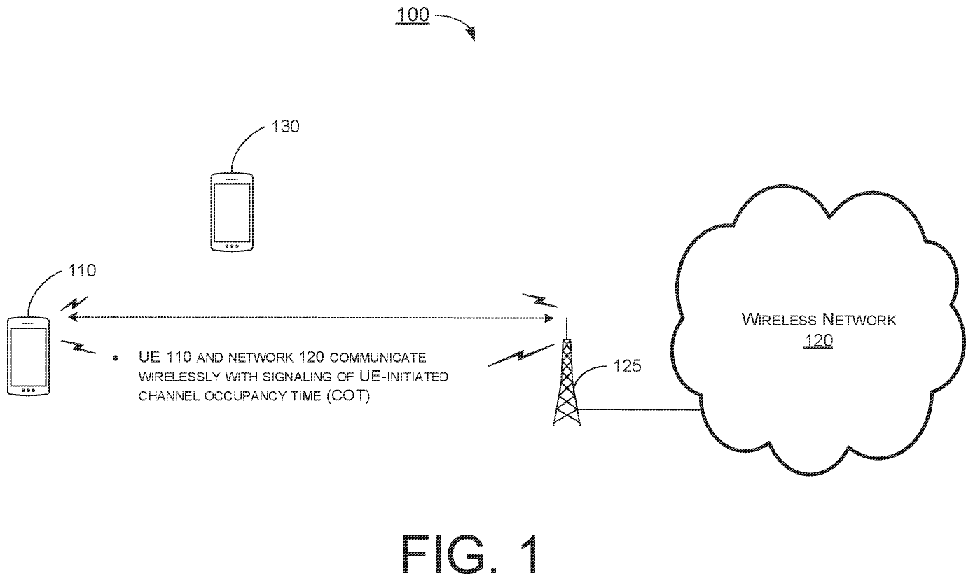

FIG. 1 illustrates an example network environment 100 in which various solutions and schemes in accordance with the present disclosure may be implemented. Referring to FIG. 1, network environment 100 may involve a user equipment (UE) 110 in wireless communication with a wireless network 120 (e.g., a 5G NR mobile network and/or another type of network such as a LTE network, a LTE-Advance network, a NB-IoT network, an IoT network, an IoT network and/or an NTN). UE 110 may be in wireless communication with wireless network 120 via a base station or network node 125 (e.g., an eNB, gNB or transmit-receive point (TRP)). Network environment 100 may optionally include one or more other UEs, represented by UE 130. In network environment 100, UE 110 and wireless network 120 may implement various schemes pertaining to signaling of UE-initiated COT in mobile communications, as described below.

Under a first proposed scheme in accordance with the present disclosure, signaling of UE-initiated COT may take place in different scenarios such as same-COT scheduling and future-FFP scheduling. In the same-COT scheduling scenario, in case that downlink control information (DCI) received by UE 110 during a network-initiated COT schedules an UL transmission that takes place in the same network-initiated COT, then the UL transmission may be performed in the network-initiated COT. This is because, under such circumstances, UE 110 is not allowed to initiate its own COT for this transmission. Moreover, in the same-COT scheduling scenario, in case that the DCI received by UE 110 during a UE-initiated COT schedules an UL transmission that takes place in the same UE-initiated COT, then the transmission may be performed in the UE-initiated COT. In an event that the DCI has a cell random network temporary identifier (C-RNTI) for dynamic grant, there may be a chance that network node 125 did not detect a configured-grant (CG) initial transmission by UE 110, and as such there would be no issue. In an event that the DCI has a configured scheduling random network temporary identifier (CS-RNTI) for retransmission of CG, then the UE-initiated COT may still be valid.

In the future-FFP scheduling scenario, in an event that DCI received by UE 110 during a network-initiated COT schedules an UL transmission that takes place in one or more future network FFPs, then the DCI may indicate one of two options. A first option may be for UE 110 to rely on the network-initiated COT and, in such a case, UE 110 may need to detect a DL signal first in the future network FFP(s). A second option may be for UE 110 to initiate its own COT.

Under a second proposed scheme in accordance with the present disclosure, in an event that DCI received by UE 110 schedules UE 110 in one or more future FFPs, there may be two options. In a first option, UE 110 may need to rely on a network-initiated COT for a given transmission, and UE 110 may assume that network node 125 will initiate a COT. Accordingly, UE 110 is not to initiate its own COT for that specific transmission. In a second option, UE 110 may need to initiate its own COT and, as such, UE 110 may not expect to check whether or not network node 125 has initiated a COT.

Under a third proposed scheme in accordance with the present disclosure, in an event that UE 110 is sharing its COT with one or more other UEs (e.g., UE 130), there may be two options. In a first option, UE 110 may transmit during FFP idle periods of UE 130. Accordingly, UE 130 may signal in its transmission (e.g., in configured grant uplink control information (CG-UCI)) that UE 130 is using a UE-initiated COT shared by UE 110 or that UE 130 is initiating its own COT. In a second option, UE 110 may not transmit during the FFP idle periods of UE 130.

Under a fourth proposed scheme in accordance with the present disclosure, when network node 125 shares a COT initiated by UE 110 during an FFP associated with UE 110, the sharing may be satisfied under one of several options. In a first option, the sharing may be satisfied when UE 110 has signaled an indication of the sharing. In a second option, the sharing may be satisfied when network node 125 uses the UE-initiated COT. In a third option, the sharing may be satisfied when network node 125 explicitly signals that it is using the UE-initiated COT. For instance, network node 125 may signal an indication by using a DCI bit-field (e.g., a value “0” in the DCI bit-field indicates that network node 125 is using network-initiated COT and a value “1” in the DCI bit-field indicates that network node 125 is using UE-initiated COT, or vice versa). Alternatively, network node 125 may signal an indication by using different demodulation reference signal (DMRS) encoding (e.g., a first DMRS encoding signals that network node 125 is using network-initiated COT and a second DMRS encoding signals that network node 125 is using UE-initiated COT). Under the proposed scheme, UE 110 may determine whether network node 125 is using a network-initiated COT or sharing a UE-initiated COT (e.g., based on an indication from network node 125 such as a DCI bit-field or different DMRS encoding). For instance, in case that network node 125 is sharing and using a COT initiated by UE 110 (or another UE), then network node 125 may signal one or more FFP parameters of the UE-initiated COT and explicitly signal that it is using the UE-initiated COT. Moreover, network node 125 may signal to other UE(s) to use the UE-initiated COT or which has initiated the COT. In an event that one or multiple UEs are sharing their COTs to network node 125, there may be several options. In a first option, network node 125 may be allowed to reject sharing of a specific UE-initiated COT. In a second option, network node 125 may be allowed to select one or multiple UE-initiated COTs to share simultaneously. In a third option, network node 125 may be allowed to share one UE-initiated COT (but not more than one) at any given time. Moreover, network node 125 may signal which one(s) of the UE-initiated COTs it has selected to share.

Under a fifth proposed scheme in accordance with the present disclosure, network node 125 may signal to UE 110 to skip some CG transmission occasions. For instance, network node 125 may signal or configure UE 110 one or more specific CG transmission occasions that UE 110 is to skip. Alternatively, or additionally, network node 125 may signal to UE 110 one or more FFP parameters of another UE (e.g., UE 130) and indicate to UE 110 to skip CG transmissions when overlap between transmissions of UE 110 and UE 130 occurs.

### Illustrative Implementations

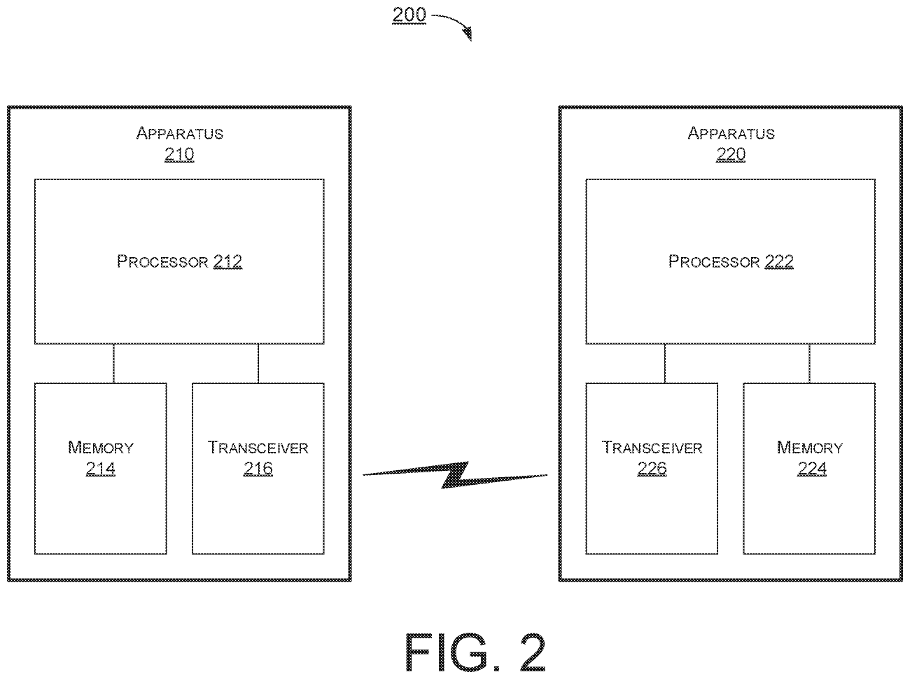

FIG. 2 illustrates an example communication system 200 having an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to signaling of UE-initiated COT in mobile communications, including scenarios/schemes described above as well as processes described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an IoT, NB-IoT, IoT or NTN apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus/station, which may be a network node such as a base station, a small cell, a router, a gateway or a satellite. For instance, network apparatus 220 may be implemented in an eNodeB in an LTE, in a gNB in a 5G, NR, IoT, NB-IoT, IoT, or in a satellite in an NTN network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, one or more RISC processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including signaling of UE-initiated COT in mobile communications in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively.

Each of communication apparatus 210 and network apparatus 220 may be a communication entity capable of communicating with each other using various proposed schemes in accordance with the present disclosure. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE (e.g., UE 110) and network apparatus 220 is implemented in or as a network node or base station (e.g., network node 125) of a communication network (e.g., wireless network 120). It is also noteworthy that, although the example implementations described below are provided in the context of mobile communications, the same may be implemented in other types of networks.

Under various proposed schemes pertaining to signaling of UE-initiated COT in mobile communications in accordance with the present disclosure, with communication apparatus 210 implemented in or as UE 110 and network apparatus 220 implemented in or as network node 125 in network environment 100, processor 212 of communication apparatus 210 may receive, via transceiver 216, an indication from apparatus 220 as a network node of a network (e.g., network node 125 of wireless network 120). Additionally, processor 212 may determine, based on the indication, whether apparatus 220 is using a network-initiated COT or sharing a UE-initiated COT.

In some implementations, the indication may include a DCI bit-field. For instance, in response to the DCI bit-field having a first value, apparatus 220 may be using the network-initiated COT. Moreover, in response to the DCI bit-field having a second value different from the first value, apparatus 220 may be sharing the UE-initiated COT.

In some implementations, the indication may include a DMRS encoding. For instance, in response to the DMRS encoding being a first DMRS encoding, apparatus 220 may be using the network-initiated COT. Moreover, in response to the DMRS encoding being a second DMRS encoding different from the first DMRS encoding, apparatus 220 may be sharing the UE-initiated COT.

In some implementations, the UE-initiated COT may be obtained by another UE.

In some implementations, processor 212 may perform additional operations. For instance, processor 212 may obtain, via transceiver 216, the UE-initiated COT. Furthermore, processor 212 may perform, via transceiver 216, an UL transmission during the UE-initiated COT.

Under other proposed schemes pertaining to signaling of UE-initiated COT in mobile communications in accordance with the present disclosure, with communication apparatus 210 implemented in or as UE 110 and network apparatus 220 implemented in or as network node 125 in network environment 100, processor 212 of communication apparatus 210 may receive, via transceiver 216, DCI from apparatus 220 as a network node of a wireless network (e.g., network node 125 of wireless network 120) which schedules an UL transmission in a future network FFP. Moreover, processor 212 may perform, via transceiver 216, the UL transmission in the future network FFP.

In some implementations, in receiving the DCI, processor 212 may receive the DCI during a network-initiated COT.

In some implementations, in performing the UL transmission, processor 212 may perform the UL transmission during a network-initiated COT.

In some implementations, in performing the UL transmission, processor 212 may perform the UL transmission during a UE-initiated COT. Moreover, processor 212 may obtain, via transceiver 216, the UE-initiated COT during the network future FFP.

### Illustrative Processes

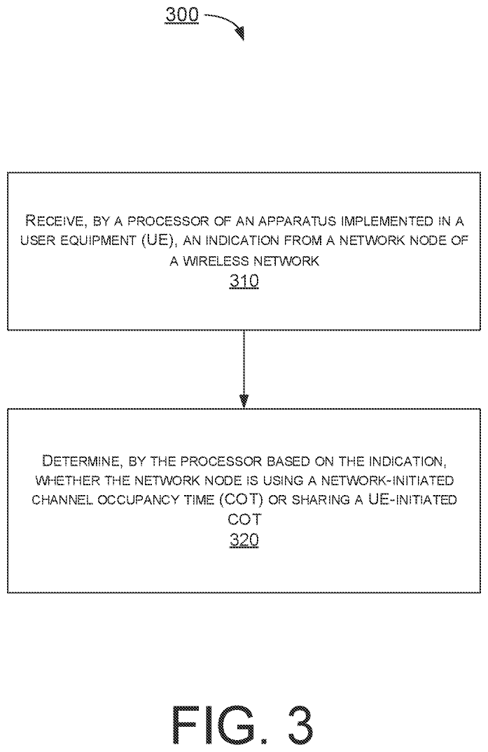

FIG. 3 illustrates an example process 300 in accordance with an implementation of the present disclosure. Process 300 may be an example implementation of schemes described above whether partially or completely, with respect to signaling of UE-initiated COT in mobile communications in accordance with the present disclosure. Process 300 may represent an aspect of implementation of features of communication apparatus 210 and network apparatus 220. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices as well as by and network apparatus 220 or any suitable network node or base station. Solely for illustrative purposes and without limitation, process 300 is described below in the context of communication apparatus 210 implemented in or as UE 110 and network apparatus 220 implemented in or as network node 125. Process 300 may begin at block 310.

At 310, process 300 may involve processor 212 of communication apparatus 210, implemented in or as UE 110, receiving, via transceiver 216, an indication from apparatus 220 as a network node of a wireless network (e.g., network node 125 of wireless network 120). Process 300 may proceed from 310 to 320.

At 320, process 300 may involve processor 212 determining, by the processor based on the indication, whether apparatus 220 is using a network-initiated COT or sharing a UE-initiated COT.

In some implementations, the indication may include a DCI bit-field. For instance, in response to the DCI bit-field having a first value, apparatus 220 may be using the network-initiated COT. Moreover, in response to the DCI bit-field having a second value different from the first value, apparatus 220 may be sharing the UE-initiated COT.

In some implementations, the indication may include a DMRS encoding. For instance, in response to the DMRS encoding being a first DMRS encoding, apparatus 220 may be using the network-initiated COT. Moreover, in response to the DMRS encoding being a second DMRS encoding different from the first DMRS encoding, apparatus 220 may be sharing the UE-initiated COT.

In some implementations, the UE-initiated COT may be obtained by another UE.

In some implementations, process 300 may involve processor 212 performing additional operations. For instance, process 300 may involve processor 212 obtaining, via transceiver 216, the UE-initiated COT. Furthermore, process 300 may involve processor 212 performing, via transceiver 216, an UL transmission during the UE-initiated COT.

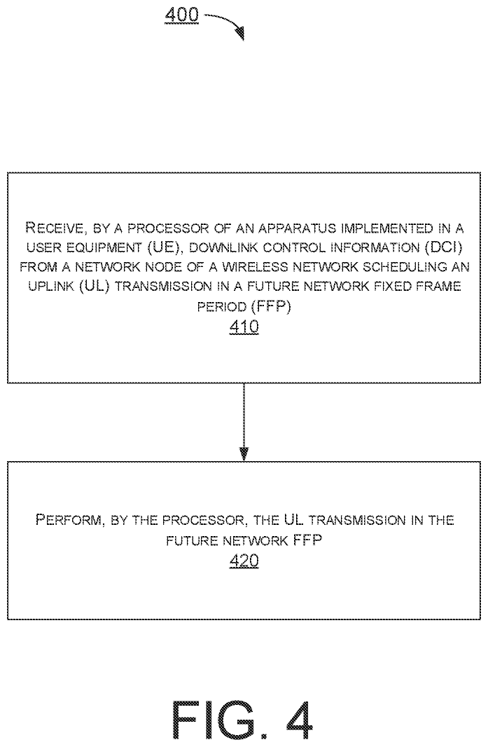

FIG. 4 illustrates an example process 400 in accordance with an implementation of the present disclosure. Process 400 may be an example implementation of schemes described above whether partially or completely, with respect to signaling of UE-initiated COT in mobile communications in accordance with the present disclosure. Process 400 may represent an aspect of implementation of features of communication apparatus 210 and network apparatus 220. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 210 or any suitable UE or machine type devices as well as by and network apparatus 220 or any suitable network node or base station. Solely for illustrative purposes and without limitation, process 400 is described below in the context of communication apparatus 210 implemented in or as UE 110 and network apparatus 220 implemented in or as network node 125. Process 400 may begin at block 410.

At 410, process 400 may involve processor 212 of communication apparatus 210, implemented in or as UE 110, receiving, via transceiver 216, DCI from apparatus 220 as a network node of a wireless network (e.g., network node 125 of wireless network 120) which schedules an UL transmission in a future network FFP. Process 400 may proceed from 410 to 420.

At 420, process 400 may involve processor 212 performing, via transceiver 216, the UL transmission in the future network FFP.

In some implementations, in receiving the DCI, process 400 may involve processor 212 receiving the DCI during a network-initiated COT.

In some implementations, in performing the UL transmission, process 400 may involve processor 212 performing the UL transmission during a network-initiated COT.

In some implementations, in performing the UL transmission, process 400 may involve processor 212 performing the UL transmission during a UE-initiated COT. Moreover, process 400 may involve processor 212 obtaining, via transceiver 216, the UE-initiated COT during the network future FFP.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus implemented in a user equipment (UE), an indication from a network node of a wireless network; and
determining, by the processor based on the indication, whether the network node is using a network-initiated channel occupancy time (COT) or sharing a UE-initiated COT.

2. The method of claim 1, wherein the indication comprises a downlink control information (DCI) bit-field.

3. The method of claim 2, wherein, responsive to the DCI bit-field having a first value, the network node is using the network-initiated COT, and wherein, responsive to the DCI bit-field having a second value different from the first value, the network node is sharing the UE-initiated COT.

4. The method of claim 1, wherein the indication comprises a demodulation reference signal (DMRS) encoding.

5. The method of claim 4, wherein, responsive to the DMRS encoding being a first DMRS encoding, the network node is using the network-initiated COT, and wherein, responsive to the DMRS encoding being a second DMRS encoding different from the first DMRS encoding, the network node is sharing the UE-initiated COT.

6. The method of claim 1, wherein the UE-initiated COT is obtained by another UE.

7. The method of claim 1, further comprising:
obtaining, by the processor, the UE-initiated COT; and
performing, by the processor, an uplink (UL) transmission during the UE-initiated COT.

8. A method, comprising:
receiving, by a processor of an apparatus implemented in a user equipment (UE), downlink control information (DCI) from a network node of a wireless network scheduling an uplink (UL) transmission in a future network fixed frame period (FFP); and
performing, by the processor, the UL transmission in the future network FFP.

9. The method of claim 8, wherein the receiving of the DCI comprises receiving the DCI during a network-initiated channel occupancy time (COT).

10. The method of claim 8, wherein the performing of the UL transmission comprises performing the UL transmission during a network-initiated channel occupancy time (COT).

11. The method of claim 8, wherein the performing of the UL transmission comprises performing the UL transmission during a UE-initiated channel occupancy time (COT).

12. The method of claim 11, further comprising:
obtaining, by the processor, the UE-initiated COT during the network future FFP.

13. An apparatus implementable in a user equipment (UE), comprising:
a transceiver configured to communicate wirelessly with a network node of a wireless network; and
a processor coupled to the transceiver and configured to perform operations comprising:
receiving, via the transceiver, an indication from the network node; and
determining, based on the indication, whether the network node is using a network-initiated channel occupancy time (COT) or sharing a UE-initiated COT.

14. The apparatus of claim 13, wherein the indication comprises a downlink control information (DCI) bit-field.

15. The apparatus of claim 13, wherein the indication comprises a demodulation reference signal (DMRS) encoding.

16. The apparatus of claim 13, wherein the processor is further configured to perform operations comprising:
obtaining, via the transceiver, the UE-initiated COT; and
performing, via the transceiver, an uplink (UL) transmission during the UE-initiated COT.

17. The apparatus of claim 13, wherein the processor is further configured to perform operations comprising:
receiving, via the transceiver, downlink control information (DCI) from the network node scheduling an uplink (UL) transmission in a future network fixed frame period (FFP); and
performing, via the transceiver, the UL transmission in the future network FFP.

18. The apparatus of claim 17, wherein, in receiving the DCI, the processor is configured to receive the DCI during the network-initiated COT.

19. The apparatus of claim 17, wherein, in performing the UL transmission, the processor is configured to perform the UL transmission during the network-initiated COT.

20. The apparatus of claim 17, wherein, in performing the UL transmission, the processor is configured to perform the UL transmission during the UE-initiated COT.
